(19) United States
(12) Patent Application Publication
(10) Pub. No.: US 2012/0160903 A1
(43) Pub. Date: Jun. 28, 2012

(54) METHOD OF JOINING METAL

(76) Inventors: Kouichi Saitou, Ogaki-shi (JP); Yoshio Okayama, Moriyama-shi (JP)

(21) Appl. No.: 13/392,835

(22) PCT Filed: May 31, 2011
(86) PCT No.: PCT/JP2011/062535

§ 371 Date: Feb. 27, 2012

(30) Foreign Application Priority Data
May 31, 2010 (JP) 2010-125303
Jan. 31, 2011 (JP) 2011-017981
Feb. 25, 2011 (JP) 2011-040076

(51) Int. Cl. B23K 31/02

(52) U.S. Cl. 228/206

(57) ABSTRACT

The present invention provides a method of joining a metal that can join coppers at a relatively low temperature by a simple technique while maintaining connection reliability.

The space between a first coating portion (14) (a copper oxide) coating a first base portion (12) (copper) and a second coating portion (24) (a copper oxide) coating a second base portion (22) (copper) is filled with a solution (30) in which the copper oxide of the first coating portion (14) and the copper oxide of the second coating portion (24) are to be eluted. As a result, the copper oxides forming the first coating portion (14) and the second coating portion (24) are eluted in the solution (30). To increase the pressure of the solution (30), pressure is applied to a first to-be-joined portion (10) and a second to-be-joined portion (20) with a pressing machine. During the pressure application, heating is performed at a relatively low temperature of 200 to 300° C., to remove the components other than the copper in the solution (30) and precipitate the copper. The first base portion (12) and the second base portion (22) are joined to each other by the precipitated copper.

### FIELD OF THE INVENTION

The present invention relates to a method of joining a metal. More particularly, the present invention relates to a method of joining coppers to each other.

### DESCRIPTION OF THE RELATED ART

Copper is widely used as the conductive material for interconnect layers forming interconnect substrates, device electrode surfaces of semiconductor chips, and the like. Conventionally-known methods of joining a metal for electrically connecting a second to-be-joined member such as a device electrode of a semiconductor chip to a first to-be-joined member such as an interconnect layer of an interconnect substrate include a method of solder-joining joining faces via a solder, a method of performing joining under pressure while the joining faces are heated to a high temperature, and a method of performing joining while the joining faces are activated by ion irradiation or the like in vacuum.

### CITATION LIST

### Patent Literature

Patent Literature 1: Japanese Patent Application Laid-Open No. 2003-100811

### DISCLOSURE OF THE INVENTION

### Problems to be Solved by the Invention

By a method of joining coppers via a solder, a Cu—Sn alloy is formed in the joined interfaces between the solder and the coppers. A Cu—Sn alloy has a relatively high electric resistance, and has low ductility. Therefore, the electrical properties of the joined portions and the connection reliability are degraded. By a method of performing joining under pressure while the joining faces are heated to a high temperature, there is a possibility that an interconnect substrate or a semiconductor chip will be damaged by heat or pressure. By a method of performing joining while the joining faces are activated in vacuum, a large-sized system such as a vacuum apparatus is required, and an increase in cost is unavoidable.

The present invention has been made in view of the above problems, and a general purpose thereof is to provide a technique to join coppers to each other at a relatively low temperature by a simple method while maintaining connection reliability.

### Means for Solving the Problems

An embodiment of the present invention is a method of joining a metal. This method of joining a metal characteristically includes: preparing a first to-be-joined portion and a second to-be-joined portion, the first to-be-joined portion including a first base portion made of a metal containing copper as a principal component and a first coating portion that coats a surface of the first base portion and is made of an oxide containing a copper oxide as a principal component, the second to-be-joined portion including a second base portion made of a metal containing copper as a principal component and a second coating portion that coats a surface of the second base portion and is made of an oxide containing a copper oxide as a principal component; filling the space between the first coating portion and the second coating portion with a solution in which the oxide of the first coating portion containing the copper oxide as the principal component and the oxide of the second coating portion containing the copper oxide as the principal component are to be eluted, and causing the metal of the first base portion containing the copper as the principal component and the metal of the second base portion containing the copper as the principal component to expose through the outermost surface of the first to-be-joined portion and the outermost surface of the second to-be-joined portion, respectively; applying pressure to the first to-be-joined portion and the second to-be-joined portion, to shorten the distance between the first to-be-joined portion and the second to-be-joined portion; and joining the copper of the first to-be-joined portion and the copper of the second to-be-joined portion to each other by heating, while the pressure is being applied to the first to-be-joined portion and the second to-be-joined portion.

By the method of joining a metal of this embodiment, coppers can be joined to each other at a relatively low temperature, without a large-sized apparatus such as a vacuum apparatus. As the first coating portion and the second coating portion are eluted in the solution, the coppers are exposed through the respective joining faces of the first to-be-joined portion and the second to-be-joined portion. That is, the joining faces of the first to-be-joined portion and the second to-be-joined portion are activated. After the joining face of the first to-be-joined portion and the joining face of the second to-be-joined portion are activated, joining is performed with the precipitated copper. Accordingly, formation of voids and generation of by-products between the joining face of the first to-be-joined portion and the precipitated and between the joining face of the second to-be-joined portion and the precipitated copper are restricted. Thus, the reliability of the connection between the first to-be-joined portion and the second to-be-joined portion can be increased.

The method of joining a metal of the above embodiment may further include cooling the joined portion after the copper of the first to-be-joined portion and the copper of the second to-be-joined portion are joined to each other. The solution may be inactive against copper. The solution may contain ligands to form complexes with copper. The complexes may be thermally-decomposable. The solution may be aqueous ammonia or an aqueous solution of carboxylic acid. The carboxylic acid contained in the aqueous solution of carboxylic acid may be multidentate ligands. Of the multidentate ligands, at least two ligands may be coordinated to one copper ion.

The method of joining a metal of the above embodiment may further include applying stress from outside to a surface of the first to-be-joined portion and a surface of the second to-be-joined portion, prior to the filling of the space between the first coating portion and the second coating portion with the solution. In this case, the applying the stress from outside may be polishing the surface of the first to-be-joined portion and the surface of the to-be-joined portion.

It should be noted that any combinations of the above described components are included in the scope of the invention claimed in this patent application.

### Effect of the Invention

According to the present invention, coppers can be joined to each other at a relatively low temperature by a simple technique while connection reliability is maintained.

### BRIEF DESCRIPTION OF THE DRAWINGS

FIG. 1 is a process chart illustrating a method of joining a metal according to a first embodiment;

FIG. 2 is a process chart illustrating the method of joining a metal according to the first embodiment;

FIGS. 3A and 3B are SIM photographs of the joined portions obtained by joining methods according to Example 1 and Comparative Example 1; and

FIG. 4 shows cross-sectional SIM images of the first to-be-joined portions after stress application or wet etching is performed by joining methods according to Example 2, Comparative Example 2, and Example 3.

### BEST MODE FOR CARRYING OUT THE INVENTION

The following is a description of embodiments of the present invention, with reference to the accompanying drawings. It should be noted that like components are denoted by like reference numerals throughout the drawings, and the same explanation will not be repeated.

### First Embodiment

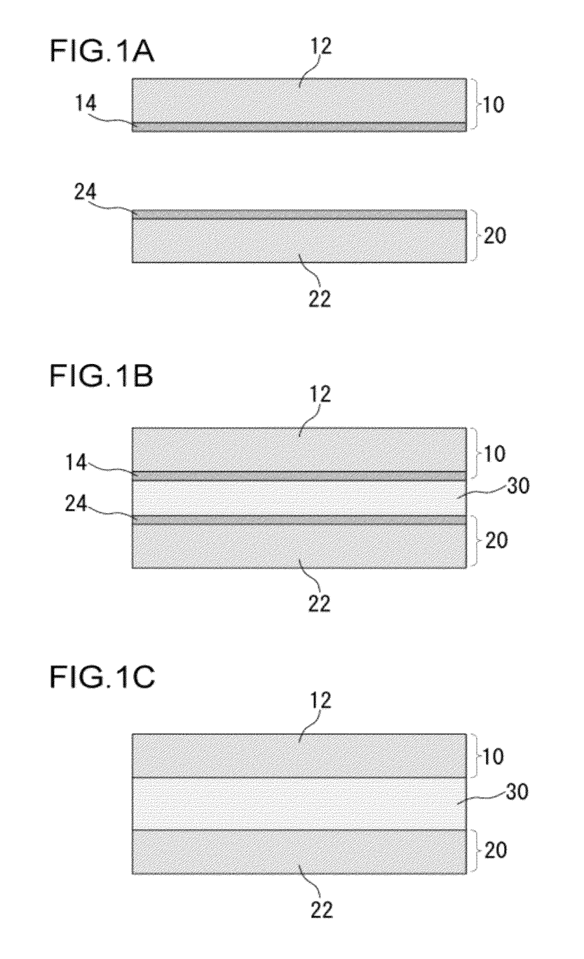

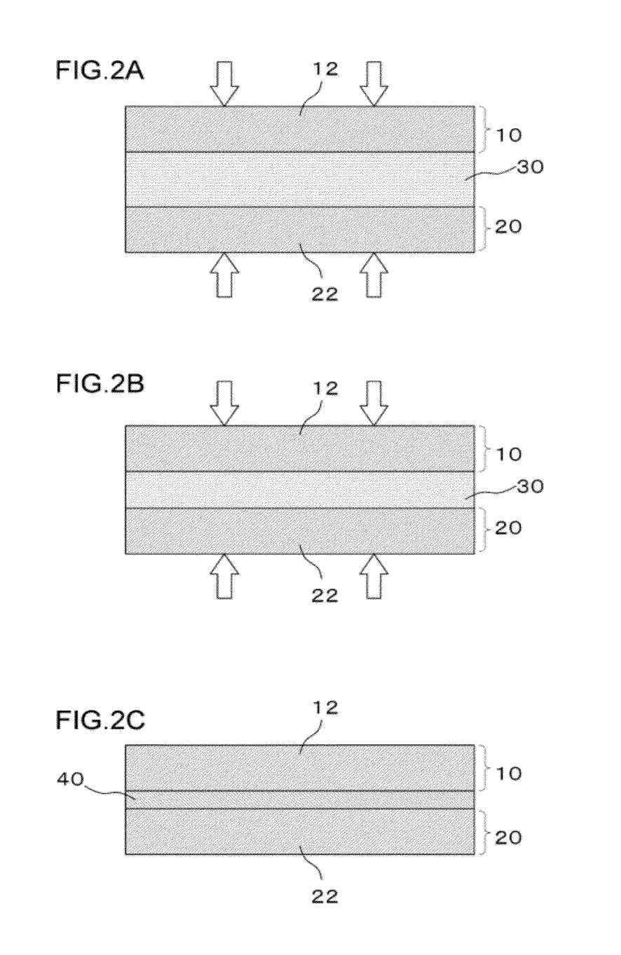

FIGS. 1 and 2 are process charts illustrating a method of joining a metal according to a first embodiment. Referring to FIGS. 1 and 2, the method of joining a metal according to the first embodiment is described.

First, as shown in FIG. 1A, a first to-be-joined portion 10 and a second to-be-joined portion 20 are prepared. The first to-be-joined portion 10 includes a first base portion 12 made of a metal containing copper as its principal component, and a first coating portion 14 coating the surface of the first base portion 12 on the joining face side. The second to-be-joined portion 20 includes a second base portion 22 made of a metal containing copper as its principal component, and a second coating portion 24 coating the surface of the second base portion 22 on the joining face side. Each of the first coating portion 14 and the second coating portion 24 is made of an oxide containing a copper oxide as its principal component. Here, “containing . . . as its principal component” in the above expressions, “containing copper as its principal component” and “containing a copper oxide as its principal component”, means that the content of the copper or the copper oxide is 50% or more.

The first base portion 12 and the second base portion 22 are not particularly limited to any specific forms, as long as they are made of a metal containing copper as their principal component. Each of the first base portion 12 and the second base portion 22 may be a deposited layer that is made of copper and is formed on a substrate such as a Si substrate by a sputtering technique, or may be an external terminal portion of an interconnect layer formed by performing patterning on a copper plate such as copper foil. The first coating portion 14 and the second coating portion 24 are thin-film coatings made of Cu₂O, specifically, and are 10 nm in thickness, for example. The first coating portion 14 and the second coating portion 24 may be intentionally-formed coatings or may be unintentionally-formed coatings. In this embodiment, the first coating portion 14 and the second coating portion 24 are natural oxide films formed by copper oxidizing in the atmosphere.

As shown in FIG. 1B, the space between the first coating portion 14 and the second coating portion 24 is filled with a solution 30 in which the copper oxide of the first coating portion 14 and the copper oxide of the second coating portion 24 are to be eluted or dissolved. In this embodiment, the solution 30 is aqueous ammonia. Where the space between the first coating portion 14 and the second coating portion 24 is filled with the solution 30, the distance between the exposed surface of the first coating portion 14 and the exposed surface of the second coating portion 24 is 1 μm, for example.

After left at room temperature for approximately one minute, the copper oxide forming the first coating portion 14 is eluted in the solution 30, and the first coating portion 14 disappears. Also, the copper oxide forming the second coating portion 24 is eluted in the solution 30, and the second coating portion 24 disappears. As the copper oxides forming the first coating portion 14 and the second coating portion 24 are eluted in the solution 30, the coppers forming the first base portion 12 and the second base portion 22 are exposed through the outermost surface (the exposed surface on the joining face side) of the first to-be-joined portion 10 and the outermost surface (the exposed surface on the joining face side) of the second to-be-joined portion 20, respectively. In the solution 30, copper complexes are formed with ammonia ions to be ligands and copper ions. In this embodiment, the copper complexes are considered to exist as thermally-decomposable tetraamine copper complex ions that are expressed as [Cu(NH₃)₄]²⁺. Since aqueous ammonia is inactive against copper, the coppers forming the first base portion 12 and the second base portion 22 do not react with the aqueous ammonia, and remain.

Next, as shown in FIG. 2A, to shorten the distance between the first to-be-joined portion 10 and the second to-be-joined portion 20, pressure is applied to the first to-be-joined portion 10 and the second to-be-joined portion 20 by using a pressing machine. The applied pressure is 1 MPa, for example.

Next, as shown in FIG. 2B, the first to-be-joined portion 10 and the second to-be-joined portion 20 having the pressure being applied thereto are then heated to a relative low temperature of 200 to 300° C., to remove the components other than the copper in the solution 30, and precipitate or recrystallize the copper. In this embodiment, water evaporates through the heating. The tetraamine copper complex ions are thermally decomposed, and the ammonia components evaporate. Accordingly, the proportion of the copper in the solution 30 becomes gradually higher, and the distance between the outermost surface of the first to-be-joined portion 10 and the outermost surface of the second to-be-joined portion 20 becomes gradually shorter by virtue of the pressure application by the pressing machine. It should be noted that, when pressure is applied to the first to-be-joined portion 10 and the second to-be-joined portion 20 to join those portions to each other, the surface of the pressing machine to be brought into contact with the first and/or second to-be-joined portion may be heated beforehand, and pressure may be applied to join the first to-be-joined portion 10 and the second to-be-joined portion 20 to each other. That is, the heating and the pressure application may be performed at the same time.

Next, as shown in FIG. 2C, when the removal of the components other than the copper in the solution 30 is completed, the outermost surface of the first to-be-joined portion 10 and the outermost surface of the second to-be-joined portion 20 are joined to each other by precipitated copper 40 made of copper derived from the copper oxides. The precipitated copper 40 excels in orientation and stability. The final thickness of the precipitated copper 40 is almost the same as the sum of the thickness of the first coating portion 14 and the thickness of the second coating portion 24 prepared in FIG. 1A. After the joining by the precipitated copper 40 is completed, the heating is stopped, and the portions joined by the precipitated copper 40 are gradually cooled to room temperature. It should be noted that the period of time from the start of the heating to the stop of the heating is 10 minutes, for example. After the cooling is completed, the pressure application is stopped, and the process of joining the first to-be-joined portion 10 and the second to-be-joined portion 20 to each other is completed.

By the method of joining a metal described above, coppers can be joined to each other at a relatively low temperature, without a large-sized system such as a vacuum apparatus. Specifically, the first coating portion 14 and the second coating portion 24 are eluted in the solution 30, and accordingly, the coppers are exposed through the respective joining faces of the first to-be-joined portion 10 and the second to-be-joined portion 20. That is, the joining faces of the first to-be-joined portion 10 and the second to-be-joined portion 20 are activated. After the joining face of the first to-be-joined portion 10 and the joining face of the second to-be-joined portion 20 are activated, joining is performed via the precipitated copper 40. Accordingly, formation of voids and generation of by-products between the joining face of the first to-be-joined portion 10 and the precipitated copper 40 and between the joining face of the second to-be-joined portion 20 and the precipitated copper 40 are restricted. Thus, the reliability of the connection between the first to-be-joined portion 10 and the second to-be-joined portion 20 can be increased.

As the precipitated copper 40 serving to join the first to-be-joined portion 10 and the second to-be-joined portion 20 to each other, the copper derived from the copper oxides existing as the oxide coatings of the first to-be-joined portion 10 and the second to-be-joined portion 20 is used. Therefore, there is no need to prepare a joining material to join the first to-be-joined portion 10 and the second to-be-joined portion 20 to each other. Accordingly, the costs required for connecting the first to-be-joined portion 10 and the second to-be-joined portion 20 to each other can be lowered.

### (Evaluations on Joined Portions)

In Example 1, a copper interconnect (26 μm in thickness) on a printed circuit board was prepared as the first to-be-joined portion, and a copper layer (0.3 μm in thickness) formed on a Si substrate by a sputtering technique was prepared as the second to-be-joined portion. Aqueous ammonia having a NH₃ concentration of 0.28% was used as the solution that fills the space between the first to-be-joined portion and the second to-be-joined portion. The applied pressure was 1 MPa, and the heating conditions were 300° C. for 10 minutes. Under those conditions, the first to-be-joined portion and the second to-be-joined portion were joined to each other.

In Comparative Example 1, the first to-be-joined portion and the second to-be-joined portion were joined to each other under the same conditions as those in Comparative Example 1, except that the solution filling the space between the first to-be-joined portion and the second to-be-joined portion was pure water.

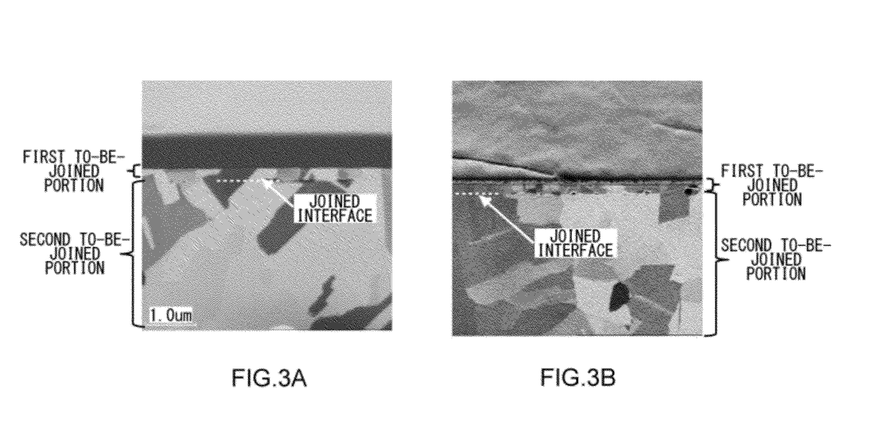

The joined portions obtained by the joining methods according to Example 1 and Comparative Example 1 were observed with a SIM (Scanning Ion Microscope). FIGS. 3A and 3B are SIM photographs of the joined portions obtained by the joining methods according to Example 1 and Comparative Example 1, respectively. As can be seen from FIG. 3B, by the joining method according to Comparative Example 1, the joined interface was relatively clear, and voids were formed in the joined interface. By the joining method according to Example 1, on the other hand, grain aggregates of copper were formed across the joined interface, and formation of voids at the joined portions was restrained, as can be seen from FIG. 3A. Accordingly, it was confirmed that a sufficient joining strength between coppers was not secured simply by using pure water as the solution to fill the space between the first to-be-joined portion and the second to-be-joined portion. However, by using aqueous ammonia, coppers were joined to each other while connection reliability was maintained.

### (Solution to be Used in Joining Metals)

By the method of joining a metal according to the above described first embodiment, aqueous ammonia is used as the solution to be used in joining metals. However, the solution is not limited to that, as long as it contains ligands that form complexes with copper. The solution may be an aqueous solution of carboxylic acid, for example.

Examples of carboxylic acids that can be used to form the aqueous solution of carboxylic acid include a monocarboxylic acid such as acetic acid, dicarboxylic acids such as oxalic acid, malonic acid, succinic acid, glutaric acid, phthalic acid, and maleic acid, and oxycarboxylic acids such as tartaric acid, citric acid, lactic acid, and salicylic acid.

Of those acids, the aqueous solution of carboxylic acid preferably contains a carboxylic acid to be multidentate ligands. In the aqueous solution of carboxylic acid containing a carboxylic acid to be multidentate ligands, the carboxylic acid and the copper form a chelate, to dramatically increase the stability of the copper complexes. As a result, the temperature required for the joining can be lowered. It should be noted that tartaric acid forming a chelate is disclosed in “Rikagaku-Jiten (Dictionary of Physics and Chemistry), the 4th Edition, published by Iwanami Shoten”, page 593. Also, formation of a chelate with tartaric acid or oxalic acid or the like is disclosed in “Mukikagaku (Inorganic Chemistry), Vol. 2, Heslop and Jones, translated by Yoshihiko Saito,” page 666. Here, chelation means a very large increase in the stability of complexes by virtue of formation of a ring with multidentate ligands.

### (Joining Experiments Using Carboxylic Acid Aqueous Solutions)

An acetic acid solution (acetic acid concentration: 10 wt %) and an oxalic acid solution (oxalic acid concentration: 10 wt %) were used as the solutions to be used in joining metals, and joining experiments were conducted by the above described joining method. It should be noted that the pressure applied at the time of joining was 1 MPa.

Where an acetic acid solution containing a monocarboxylic acid was used as the solution to be used in joining metals, a joining strength of 25 MPa or greater in shear stress was achieved at a joining temperature of 150° C. However, a sufficient joining strength was not achieved at a joining temperature of 125° C.

Where an oxalic acid solution containing a dicarboxylic acid was used as the solution to be used in joining metals, on the other hand, a joining strength of 25 MPa or greater in shear stress was achieved at a low joining temperature of 125° C. Further, a joining experiment was conducted at a lower joining temperature of 100° C. As a result, a sufficient joining strength was not achieved.

Through the above joining experiments, it was confirmed that the joining temperature can be lowered to approximately 125° C. by using an oxalic acid solution that forms a chelate with copper ions. Joining metals to each other at such a low temperature is difficult by conventional techniques, and characterizes this metal joining technique. This metal joining technique is expected to be used not only in joining electronic parts but also in a wide range of fields in future.

### Second Embodiment

A method of joining a metal according to this embodiment is a method of joining the first to-be-joined portion 10 and the second to-be-joined portion 20 to each other through the same procedures as those of the method of joining a metal according to the first embodiment, except including a procedure (hereinafter referred to as the stress applying procedure) for applying stress from outside to the surface of the first coating portion 14 and the surface of the second coating portion 24 prior to the solution introducing procedure illustrated in FIG. 1B.

Specific examples of stress applying procedures include: polishing the surface of the first coating portion 14 and the surface of the second coating portion 24; tapping the surface of the first coating portion 14 and the surface of the second coating portion 24 with a hammer-like member; and bending, blasting, or heating the first to-be-joined portion 10 and the second to-be-joined portion 20. It should be noted that, in the stress applying procedure, a strained layer should be formed on each of the surfaces of the first to-be-joined portion 10 and the second to-be-joined portion 20, and the present invention is not limited to the above described methods. If an impurity such as an organic material is generated through the stress applying procedure, it is preferable to perform cleaning after the stress applying procedure.

It should be noted that a strained layer is a layer formed with grain aggregates of copper having a smaller mean particle size than that of the copper in the first base portion 12 and the second base portion 22. The thickness of each strained layer is greater than that of the first coating portion 14 and the second coating portion 24, and may be 1 μm, for example.

After the stress applying procedure is carried out, the above described solution introducing procedure using aqueous ammonia or an aqueous solution of carboxylic acid as illustrated in FIG. 1B, the coating removing procedure illustrated in FIG. 1C, the pressure applying procedure illustrated in FIG. 2A, the heating procedure (the recrystallizing procedure) illustrated in FIG. 2B, and the cooling procedure illustrated in FIG. 2C are carried out. In this manner, the first to-be-joined portion 10 and the second to-be-joined portion 20 can be joined to each other. In this embodiment, however, a strained layer is formed on each surface through the stress applying procedure, prior to the joining of the first to-be-joined portion 10 and the second to-be-joined portion 20. In this manner, a sufficient joining strength can be achieved even if the temperature in the heating procedure is made lower (125 to 200° C., for example).

In the recrystallizing procedure, the strained layers grow into grain aggregates of copper with the same mean particle size as that of the coppers in the first base portion 12 and the second base portion 22.

(Joining Experiments about Stress Application)

In Example 2, copper plates (1.0 μm in thickness) were prepared as the first to-be-joined portion and the second to-be-joined portion. After the strained layers were formed by polishing the surface of the first to-be-joined portion and the surface of the second to-be-joined portion, the above described diffusion joining was performed. Specifically, aqueous ammonia having a NH₃ concentration of 0.28% was used as the solution that fills the space between the first to-be-joined portion and the second to-be-joined portion. The applied pressure was 6 MPa, and the heating conditions were 125° C. for 10 minutes. Under those conditions, the first to-be-joined portion and the second to-be-joined portion were joined to each other.

In Comparative Example 2, instead of the stress applying procedure, a procedure for flattening the surface of the first to-be-joined portion and the surface of the second to-be-joined portion was carried out by performing wet etching.

In Example 3, after the procedure for flattening the surface of the first to-be-joined portion and the surface of the second to-be-joined portion was carried out by performing wet etching, the strained layers were formed by polishing.

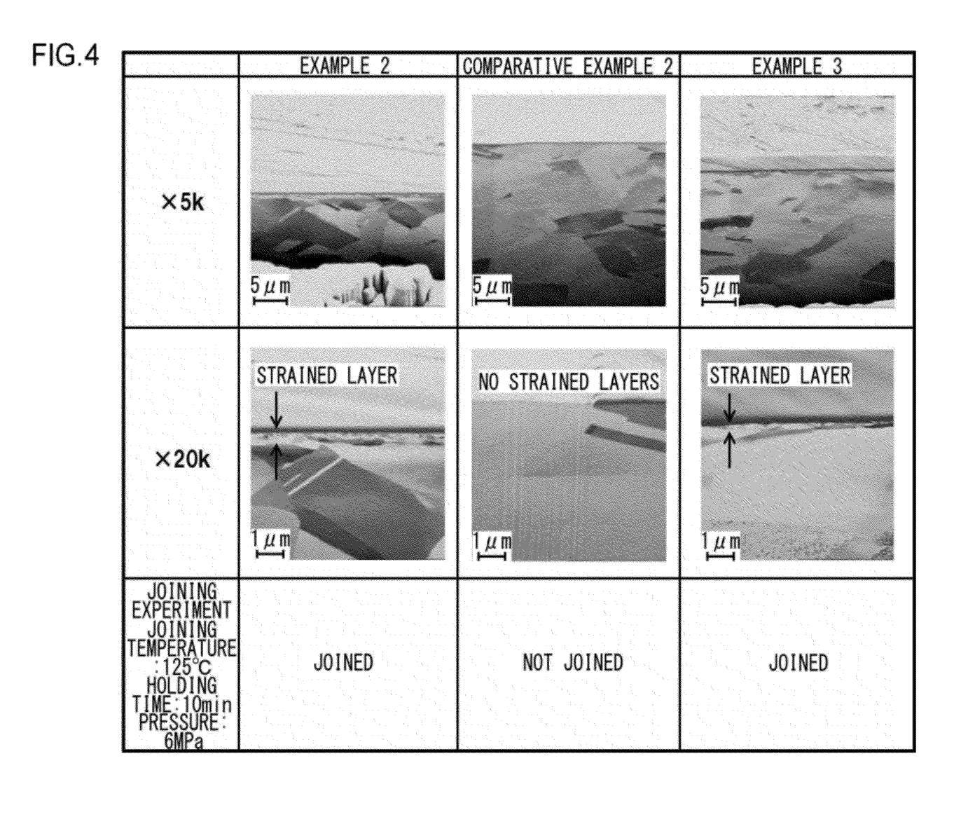

FIG. 4 shows cross-sectional SIM images of the first to-be-joined portions after stress application or wet etching was performed by the joining methods according to Example 2, Comparative Example 2, and Example 3. As shown in FIG. 4, in Examples 2 and 3, a strained layer was formed on the surface of each first to-be-joined portion. The thickness of the strained layer was 0.41 μm in both Examples 2 and 3. In Comparative Example 2, on the other hand, the surface of the first to-be-joined portion was flat, and no strained layers were formed.

The results of the joining experiments carried out by the joining methods according to Example 2, Comparative Example 2, and Example 3 confirm that, in Example 2 and Example 3, a sufficient joining strength was obtained when the shear stress was 25 MPa or more, and the thickness of each strained layer was 0.41 μm. In Comparative Example 2, on the other hand, a sufficient joining strength was not achieved, and the first to-be-joined portion and the second to-be-joined portion were easily separated from each other. As can be seen from the result of Example 3, a sufficient joining strength was achieved by forming a strained layer even where the surface of a to-be-joined portion was made flat by wet etching. Accordingly, it was confirmed that the strained layers greatly contributes to an increase in the joining strength.

The present invention is not limited to the above described embodiments, and various modifications may be made to the designs and settings on the basis of the knowledge of those skilled in the art. Such modifications made to the embodiments should be included in the scope of the invention.

### DESCRIPTION OF REFERENCE NUMERALS

10 first to-be-joined portion, 12 first base portion, 14 first coating portion, 20 second to-be-joined portion, 22 second base portion, 24 second coating portion, 30 solution, 40 precipitated copper

### INDUSTRIAL APPLICABILITY

By the method of joining a metal of the present invention, coppers can be joined to each other at a relatively low temperature by a simple technique, while connection reliability is maintained.

1-10. (canceled)

11. A method of joining a metal comprising:
preparing a first to-be-joined portion and a second to-be-joined portion, the first to-be-joined portion including: a first base portion made of a metal containing copper as a principal component; and a first coating portion that coats a surface of the first base portion and is made of an oxide containing a copper oxide as a principal component, the second to-be-joined portion including: a second base portion made of a metal containing copper as a principal component; and a second coating portion that coats a surface of the second base portion and is made of an oxide containing a copper oxide as a principal component;
filling a space between the first coating portion and the second coating portion with a solution in which the oxide of the first coating portion containing the copper oxide as the principal component and the oxide of the second coating portion containing the copper as the principal component are to be eluted, and causing of the first base portion containing the copper as the principal component and the metal of the second base portion containing the copper as the principal component to expose through an outermost surface of the first to-be-joined portion and an outermost surface of the second to-be-joined portion, respectively;
applying pressure to the first to-be-joined portion and the second to-be-joined portion, to shorten the distance between the first to-be-joined portion and the second to-be-joined portion; and
joining the copper of the first to-be-joined portion and the copper of the second to-be-joined portion to each other by heating, while the pressure is being applied to the first to-be-joined portion and the second to-be-joined portion.

12. The method of joining a metal according to claim 11, further comprising
Cooling a joined portion, after the joining of the copper of the first to-be-joined portion and the copper of the second to-be-joined portion to each other.

13. The method of joining a metal according to claim 11, wherein the solution is inactive against copper.

14. The method of joining a metal according to claim 12, wherein the solution is inactive against copper.

15. The method of joining a metal according to claim 11, wherein the solution contains ligands to form complexes with copper.

16. The method of joining a metal according to claim 12, wherein the solution contains ligands to form complexes with copper.

17. The method of joining a metal according to claim 13, wherein the solution contains ligands to form complexes with copper.

18. The method of joining a metal according to claim 14, wherein the solution contains ligands to form complexes with copper.

19. The method of joining a metal according to claim 15, wherein the complexes are thermally-decomposable.

20. The method of joining a metal according to claim 16, wherein the complexes are thermally-decomposable.

21. The method of joining a metal according to claim 17, wherein the complexes are thermally-decomposable.

22. The method of joining a metal according to claim 18, wherein the complexes are thermally-decomposable.

23. The method of joining metal according to claim 11, wherein the solution is aqueous ammonia or an aqueous solution of carboxylic acid.

24. The method of joining metal according to claim 12, wherein the solution is aqueous ammonia or an aqueous solution of carboxylic acid.

25. The method of joining metal according to claim 23, wherein the carboxylic acid contained in the aqueous solution of carboxylic acid is multidentate ligands.

26. The method of joining metal according to claim 24, wherein the carboxylic acid contained in the aqueous solution of carboxylic acid is multidentate ligands.

27. The method of joining a metal according to claim 25, wherein, of the multidentate ligands, at least two ligands are coordinated to one copper ion.

28. The method of joining a metal according to claim 26, wherein, of the multidentate ligands, at least two ligands are coordinated to one copper ion.

29. The method of joining a metal according to claim 11, further comprising
applying stress from outside to a surface of the first to-be-joined portion and a surface of the second to-be-joined portion, prior to the filling of the space between the first coating portion and the second coating portion with the solution.

30. The method of joining a metal according to claim 29, wherein the applying the stress from outside is polishing the surface of the first to-be-joined portion and the surface of the to-be-joined portion.
